(19) United States
(12) Patent Application Publication
(10) Pub. No.: US 2009/0120516 A1
(43) Pub. Date: May 14, 2009

(54) TAP ASSEMBLY FOR KITCHENS, BATHROOMS, AND THE LIKE

(76) Inventor: Marco Paini, Orta San Giulio (Novara) (IT)

Correspondence Address: DICKSTEIN SHAPIRO LLP, 1825 EYE STREET NW, Washington, DC, 20006-5403, US

(21) Appl. No.: 12/052,325

(22) Filed: Mar. 20, 2008

(30) Foreign Application Priority Data
Nov. 13, 2007 (IT) MI2007A002157

(51) Int. Cl. F16K 31/02

(52) U.S. Cl. 137/605

(57) ABSTRACT

A tap assembly for kitchens, bathrooms, and the like, having an inlet section into which pipes for fluid adapted to be intercepted by the tap, and electrical wires for the power supply of tap electrical devices flow, and having a dispensing member from which the fluid comes out in a regulated manner, provides for a joint of a flexible material connecting the inlet section to the dispensing member, and is provided with a series of inner channels in which the pipes and electrical wires are intended to run. This allows arranging pipes and electrical wires in an optimal manner, not compromising the tap assembly appearance, and having low productive costs and easiness of maintenance, repair and replacement of the pieces.

### BACKGROUND OF THE INVENTION

The present invention relates to a tap assembly for kitchens, bathrooms, and the like.

Tap assemblies are known to be provided with devices of an electromechanical type for being operated, i.e. for the interception and regulation of the fluid.

It should be understood that this involves the presence, in the tap assembly, of fluid inflow pipes and electrical wires for the power supply of the electromechanical devices.

Therefore, there is the need to optimally arrange pipes and electrical wires in the tap assembly, in order to eliminate mutual interferences, moreover between pipes and electrical wires, for clear safety reasons.

However, the pipes and electrical wires arrangement in the tap assembly must not cause a deterioration of the aesthetic appearance of the same tap assembly, which is typically of primary importance for the user.

Then, all this has not to be to the detriment of the production costs and the easiness of maintenance, repair, and replacement of the pieces.

The object of the present invention is to provide a tap assembly which is capable of meeting all the needs set forth above.

### SUMMARY OF THE INVENTION

This object is achieved by a tap assembly for kitchens, bathrooms, and the like, comprising an inlet section into which pipes for a fluid adapted to be intercepted by the tap, and electrical wires for the power supply of the tap electrical devices flow, and comprising a dispensing member which the fluid comes out from in a regulated manner, characterized in that a joint is provided comprising a series of mutually spaced inner channels, in which the pipes and electrical wires are intended to run, said joint connecting said inlet section to said dispensing member.

### BRIEF DESCRIPTION OF THE DRAWINGS

In order to better understand the invention, a description of a non-limiting, exemplary embodiment thereof is set forth below, illustrated in the annexed drawings, in which:

FIG. 1 is a perspective view of a tap assembly according to the invention;

FIG. 2 is a perspective view of an enlarged detail of an element of the tap assembly of FIG. 1;

FIG. 3 is a partial perspective view of the tap assembly of FIG. 1 with some parts partially disassembled;

FIGS. 4, 5, 6, 7 show a perspective view of details of the tap assembly as illustrated in FIGS. 1 and 3;

FIG. 8 shows a control push-button panel of the tap assembly of FIG. 1.

### DETAILED DESCRIPTION OF THE PREFERRED EMBODIMENT

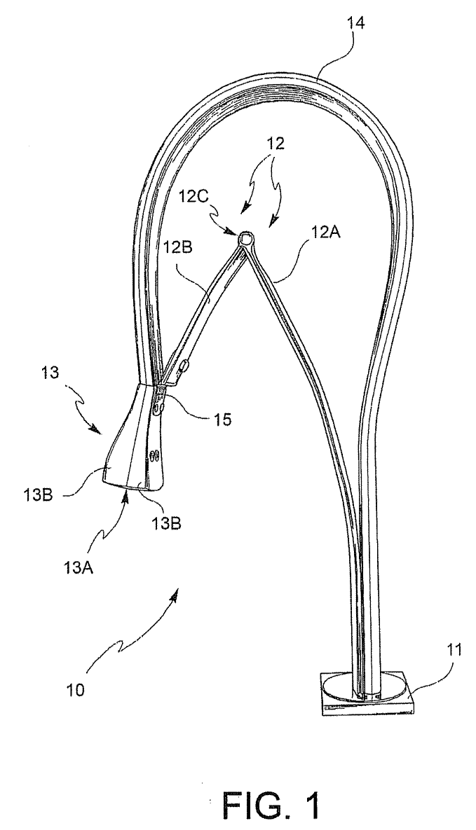

With reference to FIG. 1, the tap assembly, generally designated with 10, comprises a base 11, an articulated arm 12, a dispensing head 13, and a joint 14.

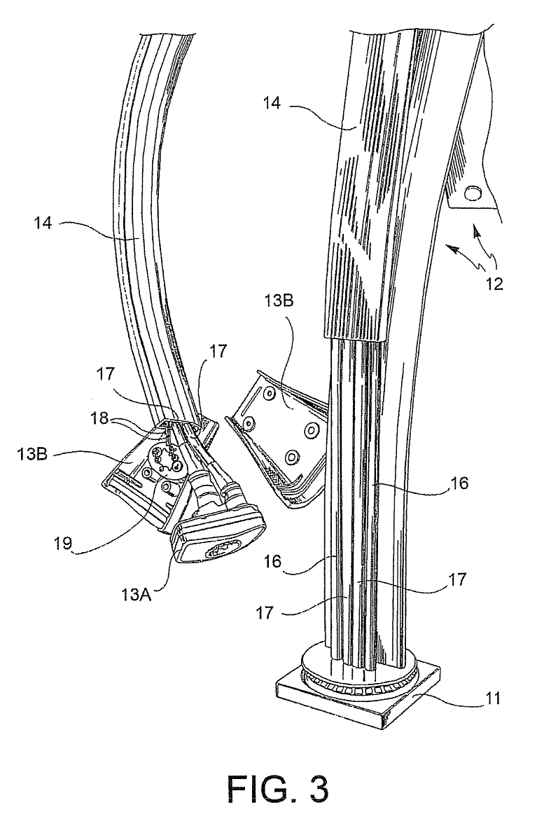

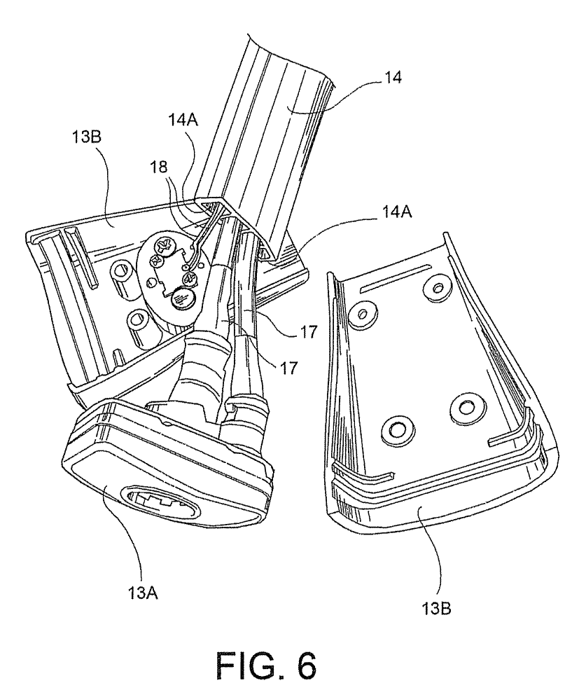

The arm 12 consists of a first length 12A and a second length 12B which are mutually connected by a hinge 12C. The free end of length 12A of the arm 12 is integral to the base 11. On the contrary, the dispensing head 13 is magnetically fastened to the free end of length 12B of the arm 12; such magnetic fastening is implemented by means of a magnetic plate 15 that is hingedly connected to the free end of length 12B of the arm 12, and to which a metallic part of the dispensing head 13 is attached by magnetic attraction. Such dispensing head 13 comprises a proper dispensing capsule 13A (well visible in the FIGS. 3, 6) which is sandwiched between two half-shells 13B.

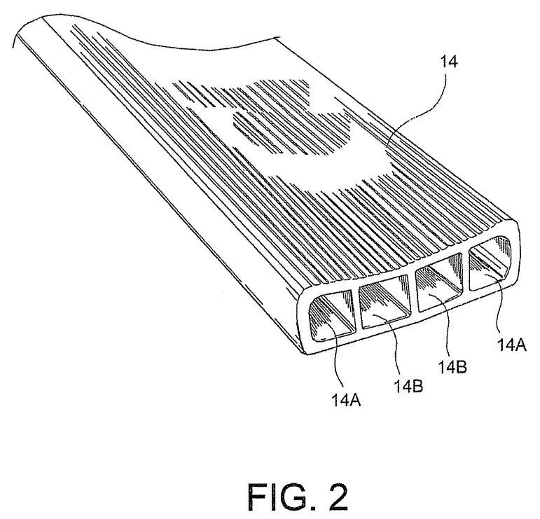

The joint 14 extends from the base 11 to the dispensing head 13, and is shown in detail in FIG. 2. Such joint 14 consists of a rectangular section bar made of flexible plastic material, for example a polymeric material such as silicone, or other, in which four mutually parallel longitudinal channels 14A, 14B are obtained, having an essentially quadrangular section.

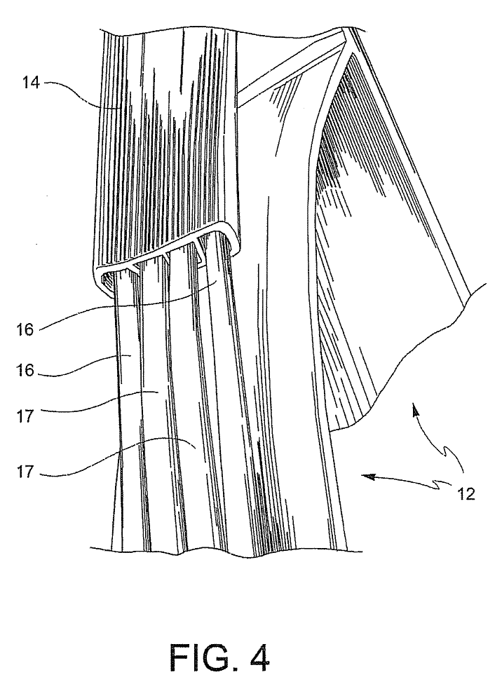

As illustrated in the FIGS. 3, 4, two rigid bars 16, for example in metal, extend in an essentially vertical manner from the base 12, which bars have such a length as to run only along an initial length in the joint 14.

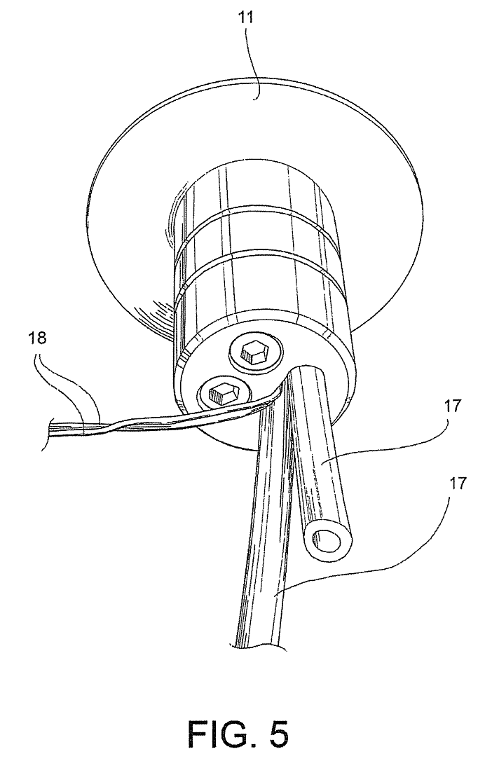

With reference to FIGS. 3, 4, 5, two flexible tubes 17, for example in plastic material, pass through the base 11, one of which is connected to a cold water source, and the other is connected to a hot water source, through suitable non-illustrated electrically controlled valving means.

Again, with reference to FIGS. 3, 4, 5, two electrical wires 18 also pass through the base 11, which are connected to said non-illustrated electrically controlled valving means.

The vertical bars 16 run into two respective side channels 14A of the joint 14 for an initial length thereof, thus being inserted into an initial end of the joint 14. Both electrical wires 18 run into one of said two side channels 14A, where one of the two bars 16 runs, then are inserted into the initial end of the joint 14 at the base 11, and come out from such joint 14 terminal end, at the dispensing head 13.

The two flexible tubes 17 run in the other two central channels 14B of the joint 14, also being inserted into the joint 14 initial end at the base 11, and also coming out from such joint 14 terminal end, at the dispensing head 13.

As shown in detail in FIG. 6, the two tubes 17 are connected to the dispensing capsule 13A at the joint 14 outlet.

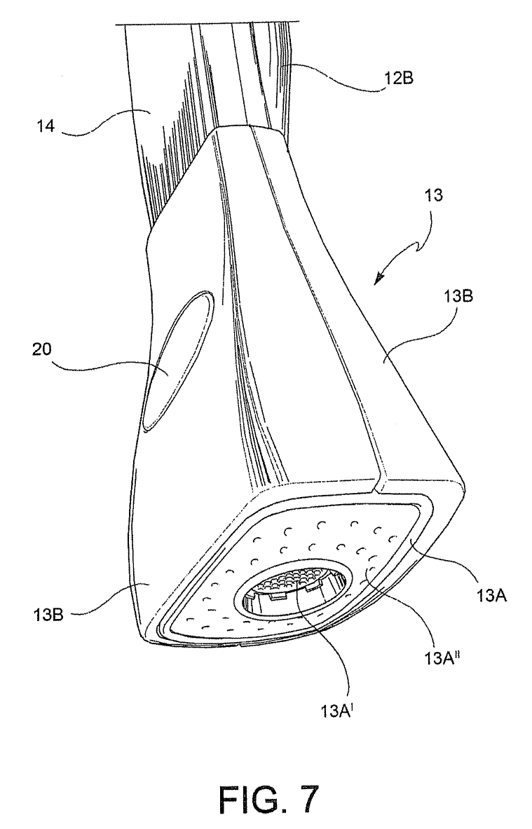

With reference to FIGS. 6, 7, the two electrical wires 18 are connected to an electromechanical device 19 with push-button control 20, which is mounted inside the two shells 13B of the dispensing head 13. Such device 19 is mechanically connected to the dispensing capsule 13A in order to control two different types of operation thereof.

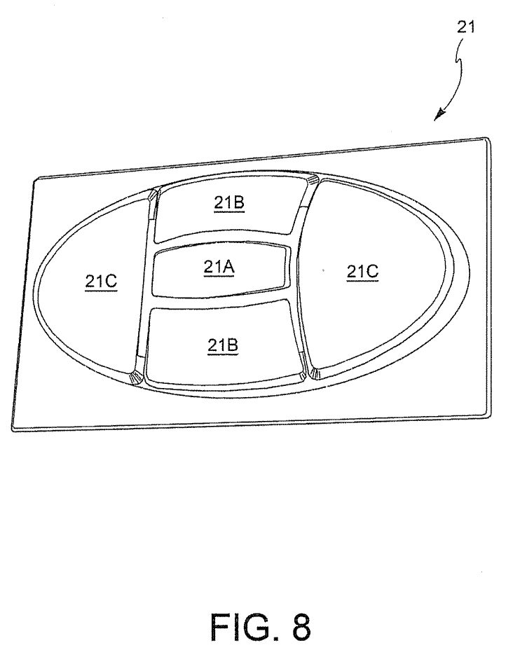

The tap is completed by a push-button panel 21, illustrated in FIG. 8, which is installed near the base 11, and which is connected to the above-mentioned electrically controlled valving means. The push-button panel 21 comprises a central push button 21A, and two pairs of peripheral push buttons, 21B and 21C.

The tap assembly 10 operation is as follows.

By pushing the central push button 21A of the push-button panel 21, the electrically controlled valving means are actuated, which provide for hot and/or cold water flowing along the tubes 17. Water arrives to the capsule 13A through such tubes 17, and is dispensed to the outside therefrom. The water supply is stopped by the same push button 21A.

By means of the pair of push buttons 21B, it is possible to increase or decrease the water flow rate by acting on the electrically controlled valving means.

By means of the pair of push buttons 21C, it is possible to mix hot and cold water to the desired degree.

By means of the push button 20 on the dispensing head 13 (FIG. 7), it is possible to select from two jet modes, that is an aerated jet (area 13A′), or a sprinkling jet (area 13A″).

All the above-described electrical, electronic, or mechanical parts which contribute to the above-mentioned tap assembly 10 operation are not described in detail herein, since they are of a known type.

By means of the articulated arm 12, it is possible to move the water dispensing head 13 to the selected area. A further freedom of movement of the dispensing head 13 is provided in that the latter can be disconnected from the arm 12 by being magnetically unfastened therefrom.

There are a number of advantages in the tap assembly 10 described and illustrated.

It should be noted that, due to the joint 14 it is possible to manage in an optimal manner the tubes 17 and electrical wires 18 in the tap assembly 10. In fact, such tubes 17 and electrical wires 18 run neatly and separately one from the other in the channels 14A and 14B; in this manner, there are no mutual interferences, moreover between tubes and electrical wires, so as to meet clear safety needs.

The aesthetic appearance of the tap assembly 10 results to be pleasant, since the tubes 17 and electrical wires 18 are not visible; instead, they are enclosed in the joint 14, and the joint appearance does not alter the tap assembly appearance compared to known tap assemblies.

The joint does not involve other productive costs, since it is a simple section bar, made of thermoplastic material manufacturable by extrusion in the example. Furthermore, the joint is easily disassemblable for maintenance, repair and replacement of the pieces, and the tubes and electrical wires are easily withdrawable from the joint.

In the present exemplary embodiment, the joint 14 also houses the two short vertical metal bars 16, which act as a partial rigid support for the same joint.

It should be understood that variations and/or additions to what has been described and illustrated herein can be provided.

The joint can be alternatively made of rigid material, such as, for example, aluminium, steel, or other. It should be apparent that the flexible material joint results to be very responsive to several needs, both technical and aesthetical.

The joint shape and section, and the channels shape, section and number can vary according to the needs. For example, the joint can be of a rounded or oval section. However, the joint of the exemplary embodiment described and illustrated above results to be functionally and aesthetically effective.

The rigid bars can be replaced by longitudinal deformable members, for example cylindrical coil spring supports of a tubular configuration.

Thanks to suitable longitudinal support members which run inside the joint, the support arm of the dispensing head can also be omitted by directly connecting the latter to such longitudinal support members.

The shape of the other parts constituting the tap assembly, i.e. the base, dispensing head, and support arm may also vary according to the needs.

The illustrated tap assembly is particularly intended for kitchens, but it can be also employed in bathrooms.

The modifications to be made to the tap assembly will be of course in accordance with the type and point of use.

What is claimed is:

1. A tap assembly for kitchens, bathrooms, and the like, comprising an inlet section into which pipes for fluid adapted to be intercepted by the tap, and electrical wires for the power supply of tap electrical devices flow, and comprising a dispensing member from which the fluid comes out in a regulated manner, characterized in that a joint is provided comprising a series of mutually spaced inner channels, in which the pipes and electrical wires are intended to run, said joint connecting said inlet section to said dispensing member.

2. The tap assembly according to claim 1, wherein said joint is of a flexible material.

3. The tap assembly according to claim 1, wherein the channels which are intended to receive the electrical wires are separated from the channels which are intended to receive the pipes.

4. The tap assembly according to claim 1, wherein said joint consists of a section bar in which said channels are obtained.

5. The tap assembly according to claim 4, wherein said section bar consists of thermoplastic material.

6. The tap assembly according to claim 5, wherein said section bar is manufactured by extrusion.

7. The tap assembly according to claim 1, wherein said joint is of a rectangular section.

8. The tap assembly according to claim 1, wherein said joint channels are of an essentially quadrangular section.

9. The tap assembly according to claim 2, wherein rigid members are provided, which run inside said joint channels.

10. The tap assembly according to claim 2, wherein deformable members are provided, which run inside said joint channels.

11. The tap assembly according to claim 10, wherein said deformable members comprise cylindrical coil spring supports with a tubular configuration.

12. The tap assembly according to claim 1, comprising an articulated arm for the support of said dispensing member associated to said joint.
